(19) United States
(12) Patent Application Publication
(10) Pub. No.: US 2017/0065878 A1
(43) Pub. Date: Mar. 9, 2017

(54) BLOCK, METHOD AND USER TERMINAL FOR PROVIDING A GAME BY SETTING CONTROL RELATION BETWEEN THE BLOCK AND A TOY

(71) Applicant: MOTIONBLUE INC., Seoul (KR)

(72) Inventor: Je-hoon Hong, Seoul (KR)

(21) Appl. No.: 14/966,253

(22) Filed: Dec. 11, 2015

(30) Foreign Application Priority Data
Sep. 9, 2015 (KR) 10-2015-0127651
Sep. 9, 2015 (KR) 10-2015-0127653

(51) Int. Cl. A63F 13/2145; A63F 13/25

(52) U.S. Cl. CPC A63F 13/2145; A63F 13/25

(57) ABSTRACT

A method and a user terminal for providing a game by setting control relation between a block and a movable toy. The block includes an input unit configured to receive a sensing value sensed by a sensor or data transmitted from an external device, an output unit configured to output the received sensing value or the received data, a communication unit configured to receive the data from the external device or transmit the sensing value to an outside device, through wireless communication, a power supply unit configured to supply a power to the input unit, the output unit and the communication unit and a pattern unit formed on a lower side of the block and configured to have a pattern which is an identification information of the block. Here, the block is disposed on a screen of a user terminal, control relation between the block and a toy or another block disposed on the screen of the user terminal is set, and the pattern unit is contacted with the screen of the user terminal so that the user terminal identifies the pattern unit.

### CROSS-REFERENCE TO RELATED APPLICATION

This application claims priority to Korean Application No. 10-2015-0127651 filed on Sep. 9, 2015 and Korean Application 10-2015-0127653 filed on Sep. 9, 2015. The applications are incorporated herein by reference.

### TECHNICAL FIELD

The present disclosure relates to a technique for providing a game by setting control relation between a block and a movable toy.

### BACKGROUND ART

A movable toy such as a robot can arouse user's curiosity according as a control means has diversified.

The control means such as a wireless remote controller or a wire remote controller, etc. was used in past, but techniques for controlling the movable toy using various sensors, e.g. technique for controlling the movable toy using a voice according to development of a voice recognition technique and so on, have been developed.

However, since the sensor is built in the movable toy, control of the movable toy is limited to control using only the sensor, and a sensing value for controlling the movable toy is predetermined. Accordingly, a user feels easily aversion about a play using the movable toy and it is difficult to perform creative learning using the movable toy.

### SUMMARY

Accordingly, the present invention is provided to substantially obviate one or more problems due to limitations and disadvantages of the background art, and one embodiment of the invention provides a method of providing a creative game using a movable toy and a block for controlling the movable toy.

Another embodiment of the invention provides a method of providing intuitively control relation between a movable toy and a block for controlling the movable toy.

Still another embodiment of the invention provides a method of combining blocks to control a movable toy and a method of setting control relation between the combined blocks and the movable toy.

A block according to one embodiment of the invention includes an input unit configured to receive a sensing value sensed by a sensor or data transmitted from an external device; an output unit configured to output the received sensing value or the received data; a communication unit configured to receive the data from the external device or transmit the sensing value to an outside device, through wireless communication; a power supply unit configured to supply a power to the input unit, the output unit and the communication unit; and a pattern unit formed on a lower side of the block and configured to have a pattern which is an identification information of the block. Here, the block is disposed on a screen of a user terminal, control relation between the block and a toy or another block disposed on the screen of the user terminal is set, and the pattern unit is contacted with the screen of the user terminal so that the user terminal identifies the pattern unit.

A user terminal for providing a game by setting control relation between a block and a toy according to one embodiment of the invention includes an identification unit configured to identify one or more of the block and the toy disposed on a screen; a control relation setting unit configured to set control relation to control the identified toy according to an operation attribute of the identified block; and a control command providing unit configured to perform specific function corresponding to the block and the toy having the control relation in the game executed on the user terminal. Here, the operation attribute includes one or more of an identifier of the toy having the control relation with the block, data sensed by the block and a control command for controlling the toy according to the sensed data, and the control command providing unit performs specific function corresponding to the block and the toy in the game according to the sensed data and the control command.

A method of providing a game by setting control relation between a block and a toy through a user terminal according to one embodiment of the invention includes (a) identifying one or more of the block and the toy disposed on a screen; (b) setting control relation to control the identified toy according to an operation attribute of the identified block; and (c) performing specific function corresponding to the block and the toy between which the control relation is set in the game executed on the user terminal. Here, the operation attribute includes one or more of an identifier of the toy having the control relation with the block, data sensed by the block and a control command for controlling the toy according to the sensed data, and the specific function corresponding to the block and the toy is performed in the game according to the data sensed by the block and the control command in the step of (c).

In one embodiment of the invention, a user can enjoy creatively a game by using a movable toy and a block for controlling the movable toy.

Additionally, various blocks for controlling the movable toy use for the game, thereby incurring continuously user's curiosity.

Furthermore, the user may set easily and excitingly control relation between the movable toy and the block for controlling the movable toy.

Moreover, since the control relation between various blocks and the movable toy is set, a control means of the movable toy diversifies, and thus user's curiosity may be continuously incurred.

In addition, it is possible to perform creative learning through setting of the control relation between the movable toy and various blocks and setting of control relation for combination of the blocks.

Effect of the invention is not to effect mentioned above, and may include every effect capable of being inferred from description or claims of the invention.

### BRIEF DESCRIPTION OF DRAWINGS

Example embodiments of the present invention will become more apparent by describing in detail example embodiments of the present invention with reference to the accompanying drawings, in which:

FIG. 1 is a view illustrating a system for providing a game using a block and a movable toy according to one embodiment of the invention;

FIG. 2 is a block diagram illustrating a block according to one embodiment of the invention;

FIG. 3 is a block diagram illustrating a user terminal according to one embodiment of the invention;

FIG. 4 is a flowchart illustrating a process of setting control relation between a block and a movable toy according to one embodiment of the invention;

FIG. 5 is a flowchart illustrating a process of providing a game using a block and a movable toy according to one embodiment of the invention;

FIG. 6 is a view illustrating a method of setting control relation between a block and a movable toy according to one embodiment of the invention;

FIG. 7 is a view illustrating a method of setting operation attribute of a block according to one embodiment of the invention;

FIG. 8 is a view illustrating a method of cancelling setting of control relation between a block and a movable toy according to one embodiment of the invention;

FIG. 9 is a view illustrating a method of setting control relation between blocks according to one embodiment of the invention; and

FIG. 10 is a view illustrating a screen of a user terminal providing a game using a block and a movable toy according to one embodiment of the invention.

### DETAILED DESCRIPTION

In the present specification, an expression used in the singular encompasses the expression of the plural, unless it has a clearly different meaning in the context.

The terminology used herein is for the purpose of describing particular embodiments only and is not intended to be limiting of the invention. As used herein, it will be understood that the terms “comprises”, “comprising,”, “includes” and/or “including”, when used herein, specify the presence of stated features, integers, steps, operations, elements, and/or configurations, but do not preclude the presence or addition of one or more other features, integers, steps, operations, elements, configurations, and/or groups thereof.

Also, terms such as “unit,” “module,” etc., as used in the present specification may refer to a part for processing at least one function or action and may be implemented as hardware, software, or a combination of hardware and software.

Hereinafter, various embodiments of the present invention will be described in detail with reference to accompanying drawings.

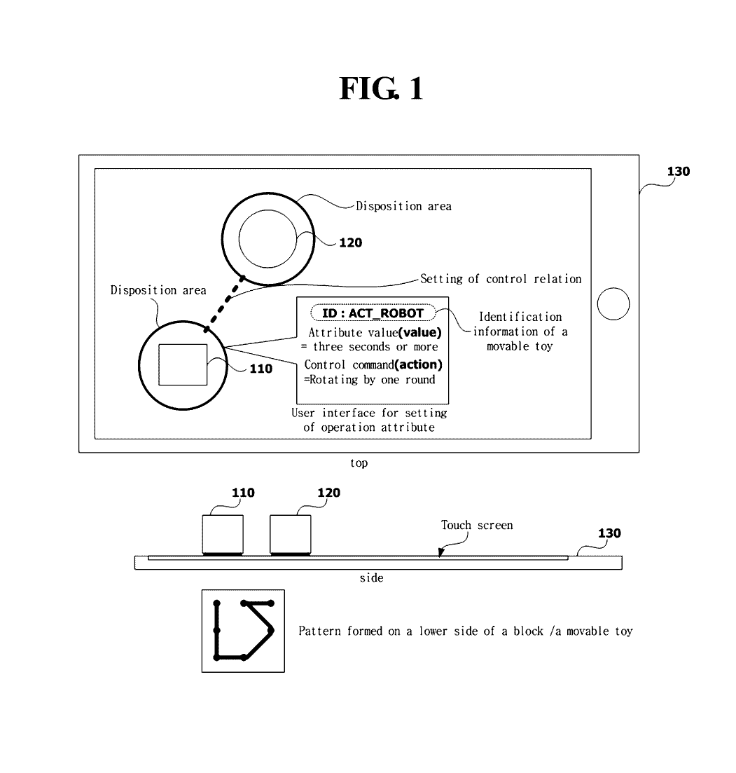

FIG. 1 is a view illustrating a system for providing a game using a block and a movable toy according to one embodiment of the invention.

The system 100 of the present embodiment may include a block 110, a movable toy 120 and a user terminal 130.

The block 110 may be disposed on a screen of the user terminal 130, and may be set to have control relation with the movable toy 120 located on the screen of the user terminal 130.

Here, control relation between the block 110 and the movable toy 120 or control relation between the block 110 and the block 110 may be set through a drag (drag and drop) between disposition areas displayed on the screen of the user terminal 130.

Additionally, various kinds of the blocks 110 may exist.

For example, the block 110 may include a block having a sensor (a voice sensor, a motion sensor, a pressure sensor, a light sensor, etc.) and an output means (an LED, a speaker, a display, etc.) and so on.

An operation attribute may be set for the block 110, to which the control relation is set, through a user interface provided on the user terminal 130.

Here, ‘operation attribute’ may include one or more of an identification information of the movable toy 120 having control relation with the block 110, data (attribute value) sensed by the block 110, a condition for delivering a control command to the movable toy 120 and the control command for controlling the movable toy 120.

In the event that the block 110 is set to have control relation with another block, the operation attribute may include at least one of an identification information of the another block having the control relation, data (attribute value) sensed by the block 110 and a condition for delivering the sensed data to the another block.

In one exemplary of the operation attribute, a movable toy 120 having an ID ACT_ROBOT can rotate by one round if user's voice (or mouth wind, etc.) is lasted for three seconds in the event that the operation attribute of the block 110 including a voice sensor is follows:

ID of the movable toy—ACT_ROBOT

Attribute value—three seconds or more

Control command (action)—rotating by one round.

The block 110 may transmit the sensed data to the user terminal 130 and include a wireless communication module capable of communicating wirelessly with the user terminal 130 to realize the transmission.

Specific pattern may be formed on a lower side of the block 110, i.e. on a part of the block 110 contacted with a screen of the user terminal 130 so that the user terminal 130 can identify the block 110. Here, the pattern may use an electrostatic way.

On the other hand, the movable toy 120 may be disposed on the screen of the user terminal 130 and be set to have control relation with the block 110 located on the screen of the user terminal 130.

The movable toy 120 may receive a control command corresponding to an attribute value set in the operation attribute of the block 110 having the control relation therewith from the user terminal 130 and operate according to the received control command.

The movable toy 120 may include a wireless communication module for communicating wirelessly with the user terminal 120. Specific pattern may be formed on a lower side of the movable toy 120, i.e. on a part of the movable toy 120 contacted with the screen of the user terminal 130 so that the user terminal 130 can identify the movable toy 120.

Here, the pattern for identifying the movable toy 120 may use an electrostatic way like the block 110.

The control command for controlling the movable toy 120 may control an operation of the movable toy 120 or control so that the specific function corresponding to the movable toy 120 can be performed in a game being executed on the user terminal 130.

The user terminal 130 may identify the block 110 or the movable toy 120 disposed on the screen, more particularly identify the block 110 or the movable toy 120 by using the patterns (for example patterns using the electrostatic way) formed on lower sides of the block 110 and the movable toy 120.

The user terminal 130 may show a disposition area on peripheral of the identified block 110 or movable toy 120 on the screen.

Here, the disposition area may be shown with an indication of notifying that the user terminal 130 identifies the block 110 or the movable toy 120 and have various shapes such as a circular shape or a rectangular shape, etc. depending on a shape of the lower side of the block 110 or the movable toy 120.

Of course, as shown in FIG. 1, the disposition area may have constant shape irrespective of the shape of the lower side of the block 110 or the movable toy 120.

A user may touch the disposition area of the block 110 or the movable toy 120 with a touch means for preset time or more and then drag the touch means into a disposition area of the block 110 or the movable toy 120 desiring to set control relation according to guidance of the user terminal 130, when the control relation between the block 110 and the movable toy 120 is set or when control relation between the blocks 110 is set. This will be described below.

The setting of the control relation may be also performed by using a drag and drop or a sequential touch (touching the disposition area of the movable toy after the disposition area of the block is touched).

In the event that the control relation is set, the user terminal 130 may store information concerning the setting of the control relation.

The user terminal 130 may show a user interface, which can set operation attribute of corresponding block 110, surrounding of the identified block 110, and store together the operation attribute inputted through corresponding user interface and the information concerning the setting of the control relation.

The user terminal 130 may be connected to the block 110 and the movable toy 120 through wireless communication.

In the event that the sensed data is received from the block 110, the user terminal 130 may transmit a control command corresponding to the received data to the movable toy 120 based on the operation attribute of the block 110.

The user terminal 130 may access to a service server (not shown) and then update information concerning the patterns of the block 110 and the movable toy 120 and information concerning a game using the block 110 and the movable toy 120.

The user terminal 130 includes a processor and a memory connected to the processor. The memory may store program commands executable operation of the user terminal 130 in the embodiments.

The user terminal 130 may be a smart phone, a tablet computer and so on which has a touch screen and disposes the block 110 and the movable 120 on the screen thereof.

Furthermore, the user terminal 130 may be an IoT (Internet of Things) terminal, and an application, which is installed in the user terminal 130 and performs the above operation, may be produced by using a Hyper Text Markup Language HTML5.

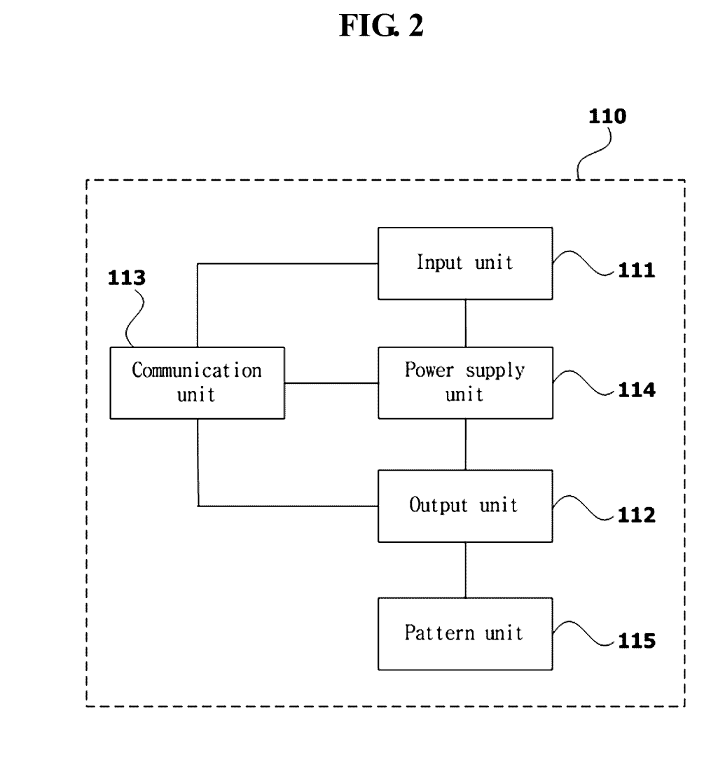

FIG. 2 is a block diagram illustrating a block according to one embodiment of the invention.

The block 110 of the present embodiment may include an input unit 111, an output unit 112, a communication unit 113, a power supply unit 114 and a pattern unit 115.

The input unit 111 may include a sensor, e.g. a voice sensor, a motion sensor, a pressure sensor, a light sensor, etc.

Hereinafter, a block including the sensor will be referred to as a sensor block.

In another embodiment, the input unit 111 may receive data sensed by other block through the communication unit 113.

Here, the data sensed by the other block is transmitted to the user terminal 130, and the communication unit 113 receives the data from the user terminal 130.

The output unit 112 may deliver data sensed through the input unit 111 including the sensor to the communication unit 113.

In one embodiment, the output unit 112 may include an LED, a speaker, a display screen, a motor, etc.

For example, in the event that the output unit 112 is the LED, the LED may be on and off or turned on according to the data sensed by the other block inputted through the input unit 111. In the event that the output unit 112 is the motor, a propeller combined with the motor may rotate depending on the data sensed by the other block inputted through the input unit 111.

That is, the sensor block may transmit data sensed by the sensor to other block or the user terminal. An exclusive output block such as a block including the LED or the speaker may output a light through the LED or output specific sound according to the data transmitted from the other block (sensor block).

Of course, a block may include together the sensor and LED, etc.

The communication unit 113 may be connected to the user terminal 130 through wireless communication such as a zigbee, a Wi-Fi, a Bluetooth, etc.

The communication unit 113 may deliver the data sensed by the other block transmitted from the user terminal 130 to the input unit 111 in the event that the block 110 is the exclusive output block including the LED or the speaker, etc.

The communication unit 113 may transmit the sensed data delivered through the output unit 112 to the user terminal 130 in the event that the block 110 is the sensor block.

The power supply unit 114 may be a rechargeable battery chargeable repeatedly a power or a disposable battery, etc., and supply a power to the input unit 111, the output unit 112 and the communication unit 113.

The pattern unit 115 may be formed on the lower side of the block 110 and the lower side is disposed on the screen of the user terminal 130. As a result, the user terminal 130 may identify the block 110 by detecting the pattern of the pattern unit 115.

Here, the pattern unit 115 may plural nodes, wherein the pattern may be formed by connecting two or more nodes.

In one embodiment, the pattern unit 115 may employ the pattern using the electrostatic way.

The operation toy 120 having control relation with the block 110 may include one or more element of which an operation is similar to operation of the elements of the block 110 mentioned above.

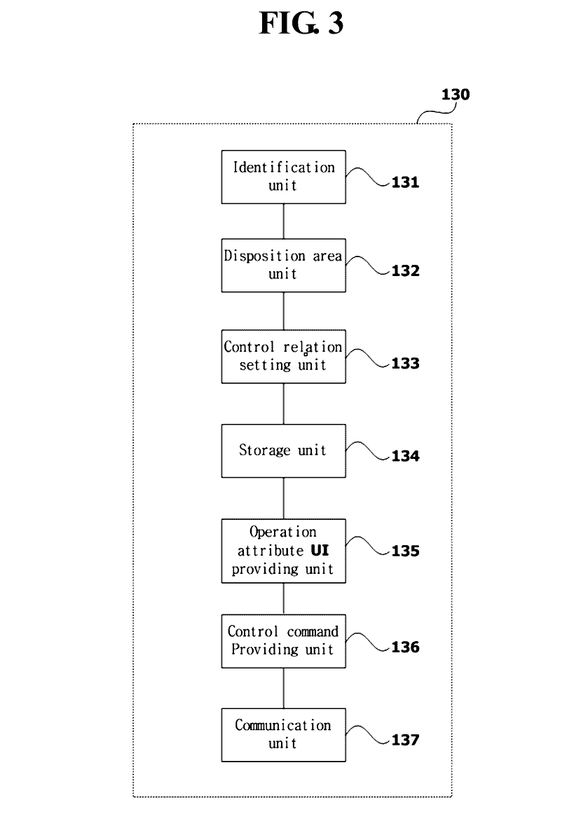

FIG. 3 is a block diagram illustrating a user terminal according to one embodiment of the invention.

The user terminal 130 of the present embodiment may include an identification unit 131, a disposition area unit 132, a control relation setting unit 133, a storage unit 134, an operation attribute UI providing unit 135, a control command providing unit 136 and a communication unit 137.

The identification unit 131 may identify the block 110 and the movable toy 120 disposed on the screen.

Particularly, the identification unit 131 may identify the block 110 or the movable toy 120 by detecting the pattern formed on the lower side of the block 110 or the movable toy 120 disposed on the screen, wherein the pattern may use the electrostatic way.

The identification unit 131 may detect a disposition area of the identified block 110 or movable toy 120 on the screen.

To perform this operation, the identification unit 131 may detect the nodes used for the pattern formed on the lower side of the block 110 or the movable toy 120, and determine location of a central node among the nodes to a location (coordinate) on which the block or the movable toy 120 is disposed.

The disposition area unit 132 may show corresponding disposition area surrounding of the block 110 or the movable toy 120 identified by the identification unit 131.

Here, the disposition area unit 132 may calculate size of the disposition area by using disposition location of the block 110 or the movable toy 120 identified by the identification unit 131 and an area of the lower side of the identified block 110 or the identified movable toy 120.

That is, the disposition location (coordinate) of the block 110 or the movable toy 120 is obtained by the identification unit 131 and the size and the shape of the lower side of the block 110 or the movable toy 120 contacted with the screen of the user terminal 130 are predetermined, and thus the disposition area unit 132 may calculate the size of the disposition area shown surrounding the identified block 110 or the identified movable toy 120.

In one embodiment, the disposition area unit 132 may set the shape of the disposition area depending on the shape of the lower side of the block 110 or the movable toy 120.

For example, the disposition area may be shown with circular shape in the event that the lower side of the block 110 or the movable toy 120 has circular shape, and may be shown with rectangular shape in the event that the lower side has rectangular shape.

The disposition area unit 132 may indicate the disposition area of the identified block 110 and the identified movable toy 120 on a location on which the block 110 and the movable toy 120 can be disposed, according to a game executed on the user terminal (game using the block and the movable toy).

Here, in the event that a block 110 and a movable toy 120 which it is impossible to use are disposed, the disposition area unit 132 may display a message for notifying the disposition of the block 110 and the movable toy 120 which it is impossible to use, based on information concerning a block 110 and a movable toy 120 usable in the game executed on the user terminal.

The control relation setting unit 133 may set the control relation between the block 110 and the movable toy 120 or the control relation between the blocks 110.

A menu or specific button/icon, etc. may be selected for the purpose of setting the control relation before the control relation is set. The control relation setting unit 133 may display disposition areas of the block 110 and the movable toy 120 settable the control relation or disposition areas of the blocks 110 settable the control relation, of the block 110 and the movable toy 120 disposed on the screen, through a method of flickering with predetermined sound and so on.

The setting of the control relation between the block 110 and the movable toy 120 or the control relation between the blocks 110 may be performed by using a drag between the disposition areas shown on the screen, a drag and drop or a sequential touch.

Here, the movable toy 120 may be set to have the control relation with at least one block 110 (1:1 or 1:N), and the block 110 may be set to have also the control relation with one or more other blocks (1:1 or 1:N).

The storage unit 134 may store information concerning the setting of the control relation between the block 110 and the movable toy 120 or the blocks 110.

The storage unit 134 may store an operation attribute with the information concerning the setting of the control relation in the event that the operation attribute of the block 110 is set through an operation attribute user interface described below.

The storage unit 134 may store information concerning games executed on the user terminal 130 and information concerning the block 110 and the movable toy 120 usable in respective games.

Additionally, the storage unit 134 may store information concerning maps of respective games and information concerning disposition location of the block 110 and the movable toy 120 in corresponding map.

The above information stored in the storage unit 134 may be compared with recent information of a service server (not shown) and its update may be determined according to the compared result, when the user terminal 130 accesses to the service server.

If the information of the service server is updated to recent information, the user terminal 130 may receive a message for notifying necessity of updating from the service server and access to the service server according to the user's request, and thus the information stored in the storage unit 134 may be updated.

The operation attribute UI providing unit 135 may display the user interface capable of inputting the operation attribute of the block 110 having the control relation with the movable toy 120 on the screen.

The control command providing unit 136 may transmit a control command defined in the operation attribute of corresponding block 110 to the movable toy 120 having the control relation with the block 110, in the event that the block 110 (of which the operation attribute is set) and the movable toy 120 between which the control relation is set are disposed on the screen and the sensed data is transmitted from the block 110.

The control command providing unit 136 may apply the block 110 and the movable toy 120 disposed on the screen to the game executed on the user terminal 130.

That is, the control command providing unit 136 may control so that it is shown that the block 110 and the movable toy 120 perform specific function or operation in the game, by using the sensed data transmitted from the block 110 disposed on the screen and the control command transmitted to the movable toy 120.

In one embodiment, if a character of the user in the game performs a mission with passing through a cave and a light sensor block is disposed on a location corresponding to the cave in a map of the game, dark inside scene of the cave may be displayed on the screen in view of the character's eyes when the character enters into the cave.

Then, in the event that the user throws a light (generated by using small lantern or a portable phone) having certain brightness on the light sensor block disposed on the screen, the light sensor block may sense the light and transmit data corresponding to the sensed result to the user terminal 130. The control command providing unit 136 may control to light inside the cave in the game with brightness corresponding to the data for the character to perform stably the mission.

In another embodiment, the game may have a function of launching a missile to an enemy camp at a missile station, and voice sensor block and the movable toy may be disposed at a location of a missile launcher in the map of the game.

In this case, if the voice sensor block senses the user's voice (for example, “launching”) meaning launching of the missile, the voice sensor block may transmit data corresponding to the sensed voice to the user terminal 130. The control command providing unit 136 may control that the missile is launched at a location corresponding to the movable toy 120 in the game according to the data.

In this case, the control command providing unit 136 may control function (flickering of the LED in the movable toy) or operation of the movable toy 120 according to a control command of the movable toy 120 defined in the operation attribute of the voice sensor block, in the event that the data is received from the voice sensor block.

The communication unit 137 may communicate wirelessly with the block 110 and the movable toy 120 through various wireless communication methods and communicate wirelessly with the service server.

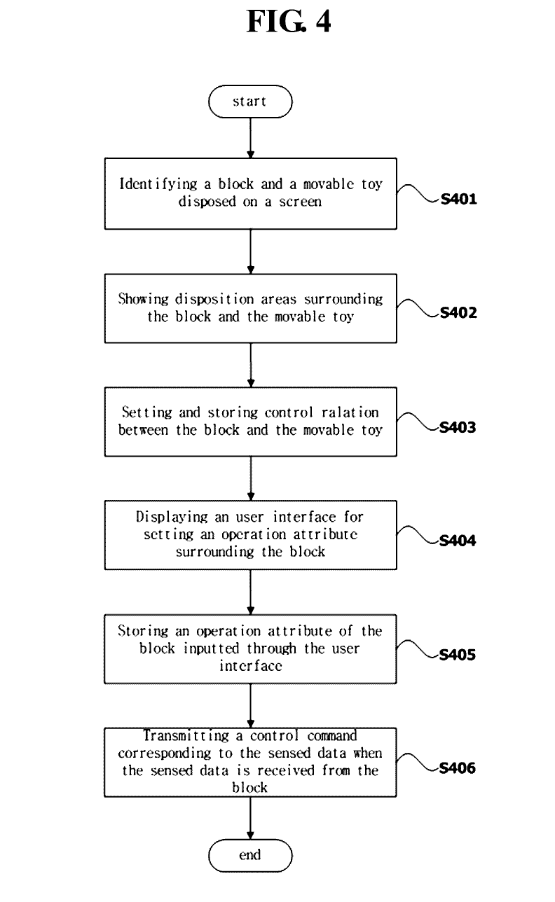

FIG. 4 is a flowchart illustrating a process of setting control relation between a block and a movable toy according to one embodiment of the invention.

The process in FIG. 4 may be performed by the user terminal 130 mentioned above. Hereinafter, the process in FIG. 4 by the user terminal 130 will be described.

In a step of S401, the user terminal 130 identifies the block 110 and the movable toy 120 disposed on the screen.

In a step of S402, the user terminal 130 displays disposition areas surrounding the identified block 110 and the identified movable toy 120, respectively.

In a step of S403, the user terminal sets control relation between the block 110 and the movable toy 120 by using dragging between the disposition areas of the block 110 and the movable toy 120, the drag and drop or the sequential touch and stores information concerning the set control relation.

In a step of S404, the user terminal 130 displays an user interface for setting an operation attribute of the block 110 surrounding the block 110 on the screen.

In a step of S405, the user terminal 130 stores the operation attribute of the block 110 inputted through the user interface.

In a step of S406, the user terminal 130 extracts a control command corresponding to a sensed data from the operation attribute of the block 110 and transmits the extracted control command to the movable toy 120, in the event that the sensed data is received from the block 110.

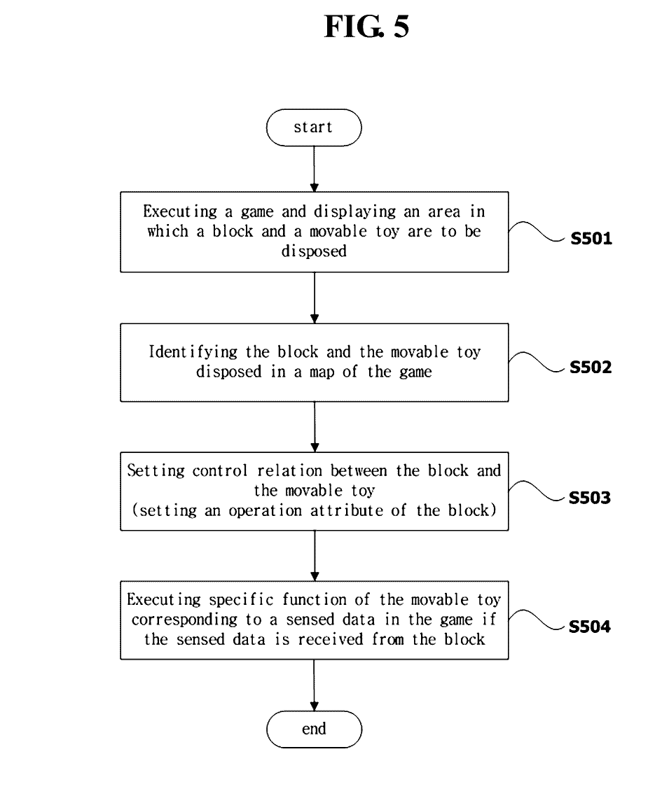

FIG. 5 is a flowchart illustrating a process of providing a game using a block and a movable toy according to one embodiment of the invention.

The process in FIG. 5 may be performed by the user terminal. Hereinafter, the process in FIG. 5 by the user terminal 130 will be described.

In a step of S501, the user terminal 130 executes a game selected by a user and displays an area where a block 110 and a movable toy 120 used in the game are disposed on a screen.

In a step of S502, the user terminal 130 identifies the block 110 and the movable toy 120 disposed on the screen, i.e. in a map of the game, if the block 110 and the movable toy 120 are disposed on corresponding areas.

In a step of S503, the user terminal 130 displays disposition areas of the identified block 110 and the identified movable toy 120 and sets control relation between the block 110 and the movable toy 120 through the drag, the drag and drop or the sequential touch by the user.

Here, an operation attribute of the block 110 may be set when the control relation is set.

In a step of S504, the user terminal 130 operates specific function of the movable toy 120 corresponding to a received data in the game, in the event that data sensed by a sensor in the block 110 is received from the block 110 while the game is being executed.

Here, the specific function of the block 110 corresponding to the received data may be performed in the game.

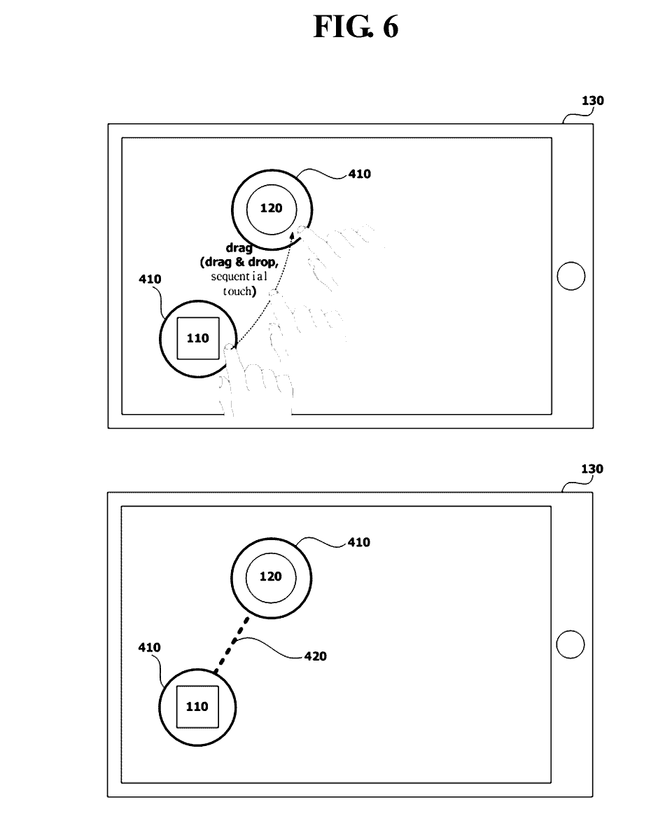

FIG. 6 is a view illustrating a method of setting control relation between a block and a movable toy according to one embodiment of the invention.

A user may verify information concerning the block 110 and the movable toy 120 and request setting of a control relation by selecting predetermined menu or button for the setting of the control relation.

If the user inputs the request of the setting of the control relation between the block 110 and the movable toy 120, the user terminal 130 may display the block 110 and the movable toy 120 between which the control relation can be set.

In this case, the user terminal 130 may display disposition areas 610 of the block 110 and the movable toy 120, between which the control relation can be set, through flickering with predetermined color, or further preset sound.

The user may drag the disposition area of the block 110 into the disposition area of the movable toy 120 as shown in FIG. 6, or drag the disposition area of the movable toy 120 into the disposition area of the block 110, thereby setting the control relation between the block 110 and the movable toy 120.

Here, the control relation may be set by the drag, the drag and drop or the sequential touch.

A control relation setting line 620 for notifying that the setting of the control relation is completed may be shown between the block 110 and the movable toy 120 between which the control relation is set, as shown in FIG. 6.

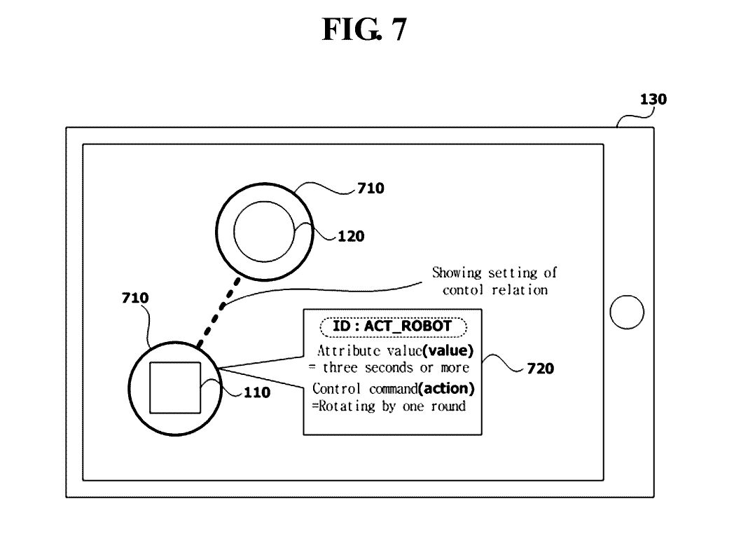

FIG. 7 is a view illustrating a method of setting operation attribute of a block according to one embodiment of the invention.

The block 110 and the movable toy 120 may be disposed on the screen of the user terminal 130, the user terminal 130 identifies the block 110 and the movable toy 120, and setting of control relation between the block 110 and the movable toy 120 is completed.

As shown in FIG. 7, disposition areas 710 may be displayed surrounding the identified block 110 and the identified movable toy 120, respectively.

If the user has touched continuously the disposition area 710 of the block 110 for preset time or more after the control relation between the block 110 and the movable toy 120 is set, the user terminal 130 may display a user interface 720 for setting the operation attribute of the block 110 on the screen as shown in FIG. 7 and receive a setting value for the operation attribute from the user.

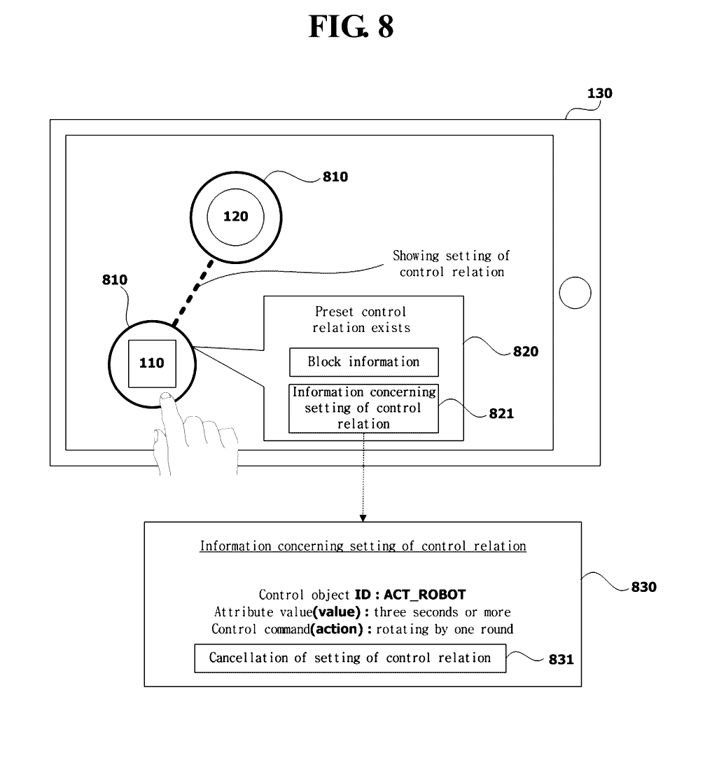

FIG. 8 is a view illustrating a method of cancelling setting of control relation between a block and a movable toy according to one embodiment of the invention.

In FIG. 8, the block 110 and the movable toy 120 are disposed on the screen of the user terminal 130, the user terminal 130 identifies the block 110 and the movable toy 120, and disposition areas 810 are disposed surrounding the identified block 110 and the identified movable toy 120, respectively.

If the user has touched continuously the disposition area 810 of the block 110 or the movable toy 120 for preset time or more, the user terminal 130 may display a user interface 820 for verifying information concerning the block 110 or the movable toy 120 and information concerning the setting of the control relation on the screen as shown in FIG. 8.

If the user selects a control relation setting button 821, the user terminal 130 may display information 830 concerning the block 110 or the movable toy 120 of which the control relation is set at present on the screen.

In the event that the user selects a control relation setting cancellation button 831, the user terminal 130 may cancel the setting of the control relation between the block 110 and the movable toy 120.

That is, if the setting of the control relation is cancelled at any one of the block 110 and the movable toy 120, every setting of the control relation for the block 110 and the movable toy 120 may be cancelled.

In the event that the setting of the control relation between the block 110 and the movable toy 120 is cancelled, the operation attribute of the block 110 may be initialized.

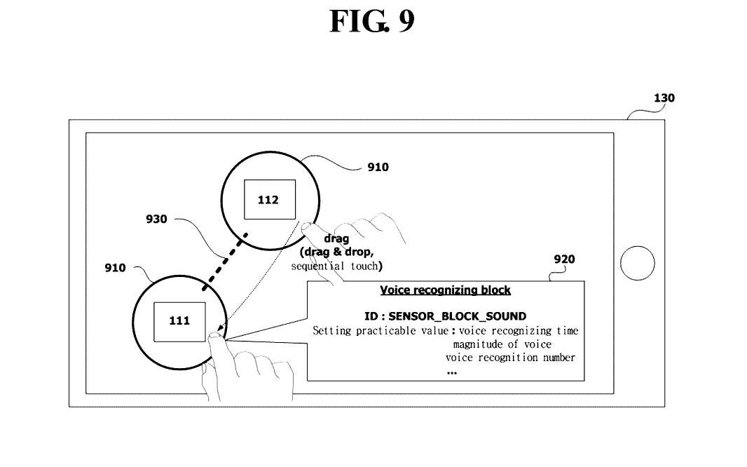

FIG. 9 is a view illustrating a method of setting control relation between blocks according to one embodiment of the invention.

In FIG. 9, a first block 111 and a second block 112 are disposed on the screen of the user terminal 130, the user terminal 130 identifies the blocks 111 and 112, and disposition areas 910 are displayed surrounding the identified blocks 111 and 112, respectively.

In an embodiment in FIG. 9, the first block 111 may be a voice sensor block and the second block 112 may be an LED block.

In the event that the user has touched continuously the disposition area 910 of the voice sensor block 111 for preset time or more, the user terminal 130 may display information 920 concerning the voice sensor block 111 on the screen.

Here, if a block or a movable toy having control relation with the voice sensor block 111 exists, the user terminal 130 may display further information concerning setting of the control relation.

Subsequently, the control relation between the blocks 111 and 112 may be set by dragging the disposition area of the LED block 112 into the disposition area of the voice sensing block 111.

Of course, the control relation may be set by dragging the disposition area of the voice sensor block 111 into the disposition area of the LED block 112.

Here, the control relation may be set through the drag and drop or the sequential touch as well as the dragging.

A control relation setting line 930 for notifying that the setting of the control relation is completed may be shown between the voice sensor block 111 and the LED block 112 between which the control relation is set, as shown in FIG. 9.

Then, in the event that the user has touched continuously the disposition area 910 of the LED block 112 for preset time or more, the user terminal 130 may display a user interface (not shown) for setting operation attribute of the LED block 112 on the screen.

Here, since the block having the control relation is the voice sensor block 111, the user interface may include an item for setting step by step brightness of the LED block 112 or setting differently color an emitted light according to level of sensed voice.

Since cancellation of the setting of the control relation between the blocks is the same as cancellation of the setting of the control relation in FIG. 8, any further description concerning the same cancellation will be omitted.

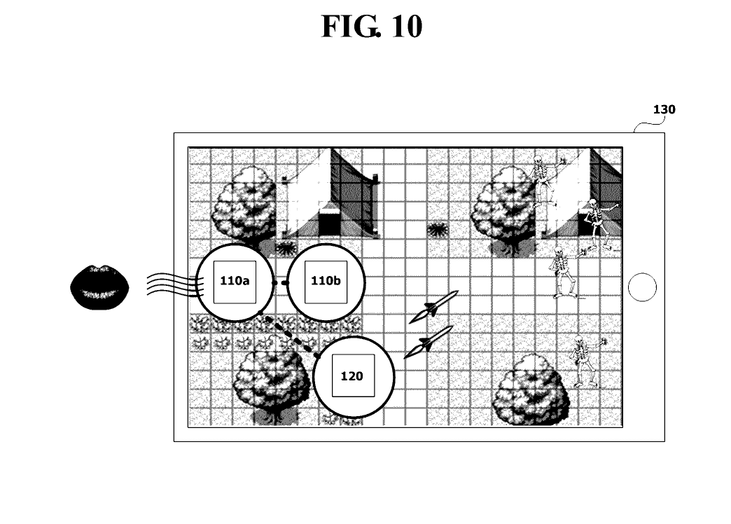

FIG. 10 is a view illustrating a screen of a user terminal providing a game using a block and a movable toy according to one embodiment of the invention.

In one embodiment, when the game is progressed by using the block 110 and the movable toy 120, the game is played after control relation between the block 110 and the movable toy 120 is set by disposing the block 110 and the movable toy 120 on the screen before the game starts, and disposition location of the block 110 and the movable toy 120 may be properly adjusted according to a map of the game.

In another embodiment, if the disposition location is displayed with the map on the screen after the game starts, the control relation may be set after the block 110 and the movable toy 120 are disposed on the disposition location.

Of course, the disposition location of the block 110 and the movable toy 120 may be freely disposed on the screen when the control relation is set.

Here, it is impossible to set the disposition location of the block 110 and the movable toy 120 at specific location such as an ocean in the map of the game.

In FIG. 10, the game is executed by using a voice sensor block 110a, an LED block 110b and the movable toy 120.

A power station for supplying a power for launching a missile is achieved by setting the control relation between the voice sensor block 110a and the LED block 110b.

For example, the user throws mouth wind to the voice sensor block 110a, the voice sensor block 110a senses the mouth wind and transmits data concerning the sensed result to the user terminal 130.

The user terminal 130 may transmit the data transmitted from the voice sensor block 110a to the LED block 110b, and the LED block 110b may light the LED with color or brightness corresponding to the data transmitted from the user terminal 130.

Here, the user terminal 130 may display the game where energy of a generator realized with combination of the voice sensor block 110a and the LED block 110b is charged depending on the data transmitted from the voice sensor block 110a.

If the energy charged to the generator is under predetermined value, the user terminal 130 may output a message or a sound for notifying that the energy of the generator should be charged by throwing mouth wind.

In the event that the energy of the generator is charged through throwing of mouth wind and the user selects a missile launching button shown in the game, the user terminal 130 may launch the missile to an enemy camp based on a location at which the movable toy is disposed, in the game.

Elements of the embodiment described above may be easily understood in view of a process.

That is, respective elements may be understood through corresponding process. Furthermore, a process in the embodiments described above may be easily understood in view of elements of the apparatus.

Also, the technical features described above can be implemented in the form of program instructions that may be performed using various computer means and can be recorded in a computer-readable medium.

Such a computer-readable medium can include program instructions, data files, data structures, etc., alone or in combination.

The program instructions recorded on the medium can be designed and configured specifically for the present invention or can be a type of medium known to and used by the skilled person in the field of computer software.

Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc.

Examples of the program of instructions may include not only machine language codes produced by a compiler but also high-level language codes that can be executed by a computer through the use of an interpreter, etc.

The hardware mentioned above can be made to operate as one or more software modules that perform the actions of the embodiments of the invention, and vice versa.

The embodiments of the invention described above are disclosed only for illustrative purposes. A person having ordinary skill in the art would be able to make various modifications, alterations, and additions without departing from the spirit and scope of the invention, but it is to be appreciated that such modifications, alterations, and additions are encompassed by the scope of claims set forth below.

1. A block comprising:
an input unit configured to receive a sensing value sensed by a sensor or data transmitted from an external device;
an output unit configured to output the received sensing value or the received data;
a communication unit configured to receive the data from the external device or transmit the sensing value to an outside device, through wireless communication;
a power supply unit configured to supply a power to the input unit, the output unit and the communication unit; and
a pattern unit formed on a lower side of the block and configured to have a pattern which is an identification information of the block,
wherein the block is disposed on a screen of a user terminal, control relation between the block and a toy or another block disposed on the screen of the user terminal is set,
and the pattern unit is contacted with the screen of the user terminal so that the user terminal identifies the pattern unit.

2. The block of claim 1, wherein the pattern unit uses an electrostatic way.

3. The block of claim 1, wherein an operation attribute of the block is set through the user terminal,
and wherein the operation attribute includes a condition and a control command for controlling the toy or the another block having the control relation with the block.

4. A user terminal for providing a game by setting control relation between a block and a toy, the user terminal comprising:
an identification unit configured to identify one or more of the block and the toy disposed on a screen;
a control relation setting unit configured to set control relation to control the identified toy according to an operation attribute of the identified block; and
a control command providing unit configured to perform specific function corresponding to the block and the toy having the control relation in the game executed on the user terminal,
wherein the operation attribute includes one or more of an identifier of the toy having the control relation with the block, data sensed by the block and a control command for controlling the toy according to the sensed data,
and the control command providing unit performs specific function corresponding to the block and the toy in the game according to the sensed data and the control command.

5. The user terminal of claim 4, wherein the control relation is set through a drag, a drag and drop or a sequential touch of areas in which the block and the toy are disposed.

6. The user terminal of claim 4, wherein the identification unit identifies the block and the toy by using patterns formed on lower sides of the block and the toy, respectively.

7. The user terminal of claim 4, further comprising:
a disposition area unit configured to show disposition areas surrounding the block and the toy, the disposition areas meaning areas in which the block and the toy are disposed.

8. The user terminal of claim 4, wherein the control relation setting unit shows completion of the setting of the control relation with a line between disposition areas for the block and the toy in the event that the control relation is set between the block and the toy.

9. The user terminal of claim 4, further comprising:
an operation attribute UI providing unit configured to display a user interface for setting the operation attribute of the block or cancelling the set control relation on the screen,
wherein the user interface sets one or more of conditions including number and size of the data sensed by the block and sets the control command to control the toy when the set condition is satisfied.

10. The user terminal of claim 4, wherein the control command providing unit transmits a control command defined in the operation attribute to the toy having the control relation with the block based on the operation attribute of the block, in the event that the data sensed by the block is received.

11. A method of providing a game by setting control relation between a block and a toy through a user terminal, the method comprising:
(a) identifying one or more of the block and the toy disposed on a screen;
(b) setting control relation to control the identified toy according to an operation attribute of the identified block; and
(c) performing specific function corresponding to the block and the toy between which the control relation is set in the game executed on the user terminal,
wherein the operation attribute includes one or more of an identifier of the toy having the control relation with the block, data sensed by the block and a control command for controlling the toy according to the sensed data,
and the specific function corresponding to the block and the toy is performed in the game according to the data sensed by the block and the control command in the step of (c).

12. The method of claim 11, wherein the control relation is set through a drag, a drag and drop or a sequential touch of areas in which the block and the toy are disposed.

13. The method of claim 11, wherein in the step of (a), the block and the toy are identified by using patterns formed on lower sides of the block and the toy, respectively.

14. The method of claim 11, wherein in the step of (c), a control command defined in the operation attribute is transmitted to the toy having the control relation with the block based on the operation attribute of the block, in the event that the data sensed by the block is received.

15. A computer program stored in a medium including a command for performing the method of claim 11.
